(19) United States
(12) Patent Application Publication
(10) Pub. No.: US 2025/0286182 A1
(43) Pub. Date: Sep. 11, 2025

(54) BATTERY

(71) Applicant: MURATA MANUFACTURING CO., LTD., Kyoto (JP)

(72) Inventor: Masayuki KAGEYAMA, Kyoto (JP)

(21) Appl. No.: 19/034,009

(22) Filed: Jan. 22, 2025

(30) Foreign Application Priority Data
Mar. 11, 2024 (JP) 2024-037148

(51) Int. Cl. H01M 50/188; H01M 50/103; H01M 50/193; H01M 50/197; H01M 50/342; H01M 50/531; H01M 50/557

(52) U.S. Cl. CPC H01M 50/188; H01M 50/103; H01M 50/193; H01M 50/197; H01M 50/3425; H01M 50/531; H01M 50/557; H01M 2200/20

(57) ABSTRACT

A battery is provided and includes an electrode body that has a first surface with a positive electrode terminal and a negative electrode terminal located thereon; and an exterior member that houses the electrode body. The exterior member includes: a box member that has a box shape including a flat plate-shaped first side part that faces the first surface and has a through hole, a flat plate-shaped second side part located on the side opposite to the first side part, and a flat plate-shaped third side part that connects the first side part and the second side part, the box member being electrically connected to the negative electrode terminal; a plate member disposed inside the through hole to be separated from the first side part in a plan view from the first side part and electrically connected to the positive electrode terminal; and a sealing body overlapped with the first side part, the plate member, a gap between the first side part and the plate member in the plan view from the first side part, the sealing body sealing the gap.

### CROSS REFERENCE TO RELATED APPLICATIONS

The present application claims priority to Japanese patent application no. 2024-037148, filed on Mar. 11, 2024, the entire contents of which are incorporated herein by reference.

### BACKGROUND

The present disclosure relates to a battery.

As an example of a battery, a rectangular battery is disclosed including a battery case with a cavity, a sealing plate for sealing the cavity, and an electrode plate group housed in the battery case. The electrode plate group has a positive electrode lead electrically connected to the sealing plate. The electrode plate group has a negative electrode lead electrically connected via an internal terminal to an external terminal penetrating the sealing plate, with the negative electrode lead electrically insulated from the sealing plate. The rectangular battery further includes a gasket and an insulator frame that electrically insulate the external terminal and the internal terminal from the sealing plate.

### SUMMARY

The present disclosure relates to a battery.

In the rectangular battery described in the Background section, the internal terminal and the insulator frame are disposed inside the battery case in which the electrode plate group (electrode body) is housed. In this case, the volume of the electrode body is reduced with respect to the volume of the battery case, and the capacity of the battery is reduced. On the other hand, there is a desire for increasing the capacity of the battery.

The present disclosure, in an embodiment, relates to providing an increase in battery capacity.

A battery according to the present disclosure, in an embodiment, includes: an electrode body that has a first surface with a positive electrode terminal and a negative electrode terminal located; and an exterior member that houses the electrode body, in which the exterior member includes: a box member that has a box shape including a flat plate-shaped first side part that faces the first surface and has a through hole, a flat plate-shaped second side part located across the electrode body from the first side part, and a flat plate-shaped third side part that connects the first side part and the second side part, the box member being electrically connected to the negative electrode terminal; a plate member disposed inside the through hole to be separated from the first side part in a plan view from the first side part, and electrically connected to the positive electrode terminal; and a sealing body overlapped with the first side part, the plate member, and a gap between the first side part and the plate member in the plan view from the first side part, the sealing body sealing the gap.

The battery according to the present disclosure, in an embodiment, allows an increase in battery capacity to be achieved.

### BRIEF DESCRIPTION OF THE FIGURES

FIG. 1 is a perspective view of a battery according to an embodiment of the present disclosure;

FIG. 2 is an exploded perspective view of the battery shown in FIG. 1;

FIG. 3 is a sectional view of the battery shown in FIG. 1;

FIG. 4 is a diagram illustrating a plan view of the battery viewed from a first side part;

FIG. 5 is an enlarged sectional view of a part of the sealing body shown in FIG. 3; and

FIG. 6 is an exploded perspective view of a battery according to a modification example of an embodiment of the present disclosure.

### DETAILED DESCRIPTION

The present disclosure will be described in further detail including with reference to the drawings according to an embodiment. It is to be noted that the present disclosure is not limited by the embodiments. Each of the embodiments is illustrative, and obviously, parts of the configurations illustrated in the different embodiments can be replaced or combined with each other.

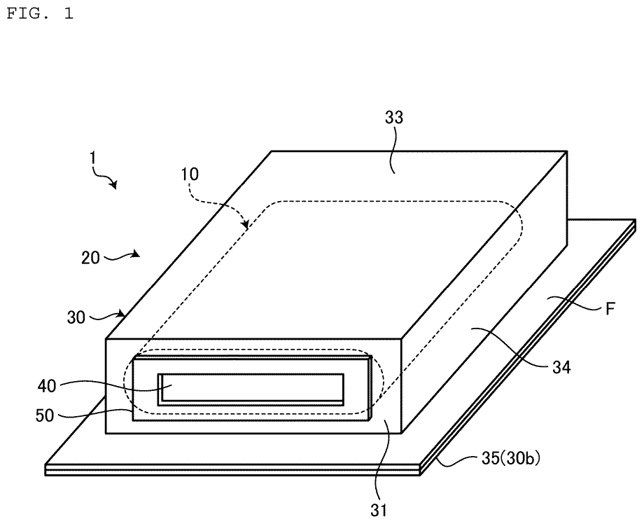

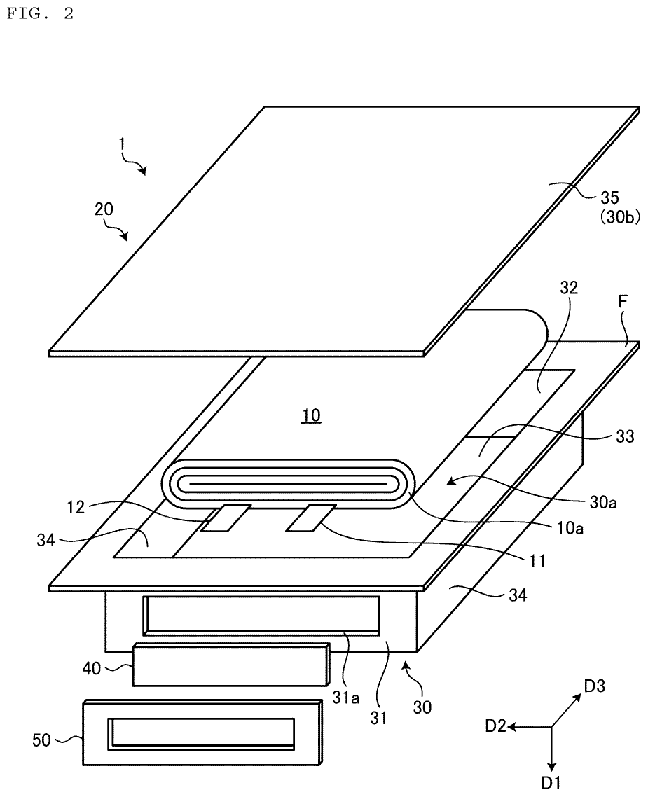

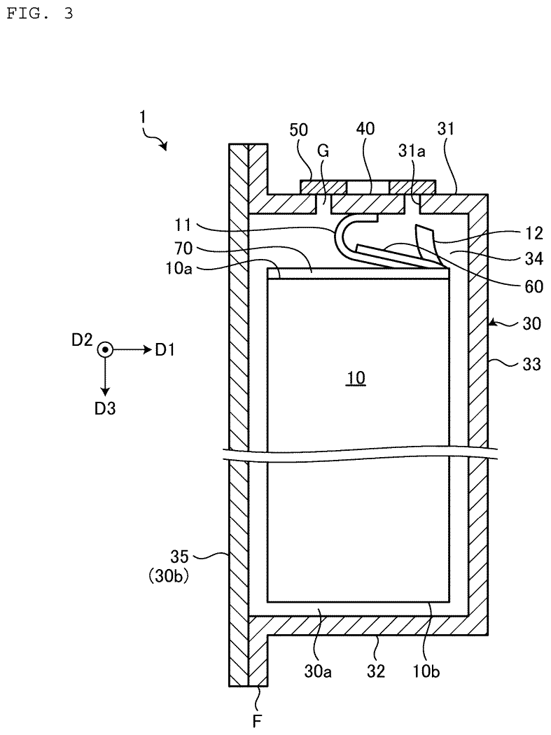

FIG. 1 is a perspective view of a battery 1 according to an embodiment of the present disclosure. FIG. 2 is an exploded perspective view of the battery 1 shown in FIG. 1. FIG. 3 is a sectional view of the battery 1 shown in FIG. 1.

The battery 1 is a secondary battery. The battery 1 is, for example, a lithium battery. The battery 1 includes an electrode body 10 and an exterior member 20.

The electrode body 10 is a wound-type electrode body. The electrode body 10 is formed by stacking and winding elongated positive electrode and negative electrode with a separator interposed therebetween. The electrode body 10 has a flattened shape. Hereinafter, the thickness direction, width direction, and depth direction of the electrode body 10 are referred to as a first direction D1, a second direction D2, and a third direction D3. The electrode body 10 has a first end surface 10a (corresponding to the “first surface”) and a second end surface 10b that face opposite sides in the third direction D3.

A first projected area of the electrode body 10 along the first direction D1 is larger than a second projected area of the electrode body 10 along the second direction D2. In addition, the second projected area is larger than a third projected area of the electrode body 10 along the third direction D3. The third projected area corresponds to the areas of the first end surface 10a and second end surface 10b. More specifically, the areas of the first end surface 10a and second end surface 10b are smaller than the first projected area and the second projected area.

The electrode body 10 includes a strip-shaped positive electrode terminal 11 electrically connected to the positive electrode and a strip-shaped negative electrode terminal 12 electrically connected to the negative electrode. The positive electrode terminal 11 and the negative electrode terminal 12 are located on the first end surface 10a of the electrode body 10.

The exterior member 20 houses the electrode body 10. The exterior member 20 includes a box member 30, a plate member 40, and a sealing body 50.

The box member 30 has a box shape in which the electrode body 10 is located. The box member 30 has conductivity. The material of the box member 30 is, for example, Fe (iron), Cu (copper), Ni (nickel), stainless steel, an iron alloy, a copper alloy, a nickel alloy, or the like. The type of stainless steel is not particularly limited, and specific examples thereof include SUS304 and SUS316.

The box member 30 has a first side part 31, a second side part 32, a third side part 33, a pair of fourth side pars 34, and a fifth side part 35.

The first side part 31 has a flat plate shape that faces the first end surface 10a of the electrode body 10 and has a through hole 31a. The second side part 32 has a flat plate shape located across the electrode body 10 from the first side part 31. The second side part 32 faces the second end surface 10b. The first side part 31 and the second side part 32 face each other with the electrode body 10 interposed therebetween in the third direction D3.

The third side part 33 has a flat plate shape that connects the first side part 31 and the second side part 32. The third side part 33 faces the electrode body 10 in the first direction D1. The pair of fourth side parts 34 has a flat plate shapes that face each other with the electrode body 10 interposed therebetween in the second direction D2. The pair of fourth side parts 34 is connected by the first side part 31, the second side part 32, and the third side part 33 in the second direction D2. The fifth side part 35 has a flat plate shape located across the electrode body 10 from the third side part 33. The third side part 33 and the fifth side part 35 face each other with the electrode body 10 interposed therebetween in the first direction D1.

In addition, the first side part 31, the second side part 32, the third side part 33, and the pair of fourth side parts 34, which are integrated, constitute a housing part 30a that is open on one side in the first direction D1. In the housing part 30a, the third side part 33 corresponds to a bottom plate, and the first side part 31, the second side part 32, and the pair of fourth side parts 34 correspond to side plates. Further, the flange part F is disposed on the peripheral edge of the cavity of the housing part 30a over the whole perimeter.

The fifth side part 35 constitutes a lid 30b that covers the cavity of the housing part 30a. The peripheral edge of the lid 30b is joined by, for example, laser welding to the flange part F over the whole perimeter. Thus, the housing part 30a and the lid 30b are electrically connected, and the housing part 30a and the lid 30b are sealed therebetween.

The negative electrode terminal 12 is joined by, for example, resistance welding to the inner surface of the housing part 30a (for example, the inner surface of the fourth side part 34). Thus, the housing part 30a is electrically connected to the negative electrode terminal 12. More specifically, the box member 30 is electrically connected to the negative electrode terminal 12.

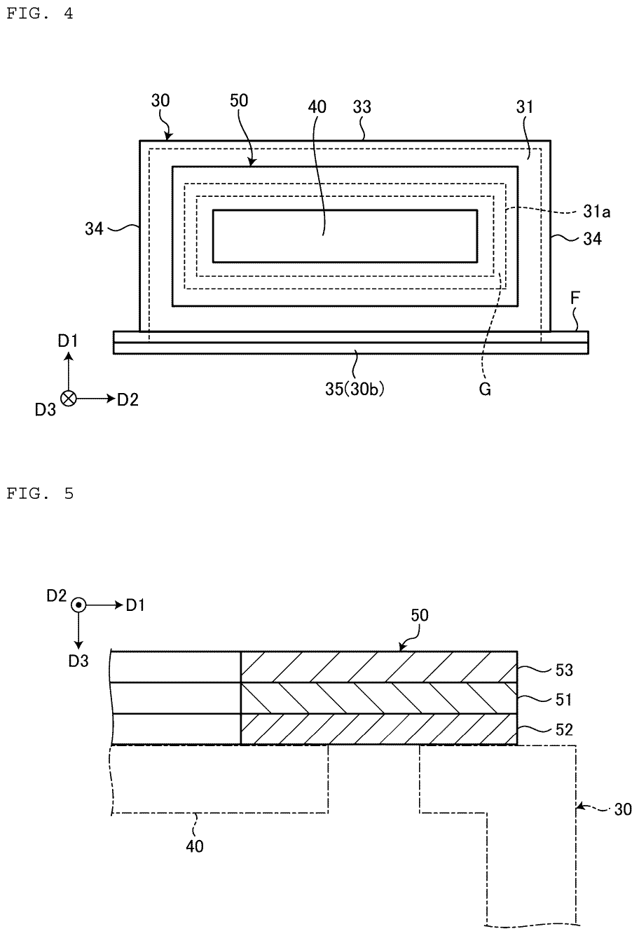

FIG. 4 is a diagram illustrating a plan view of the battery 1 viewed from the first side part 31.

The plate member 40 shown in FIGS. 1, 2, 3, and 4 has a flat plate shape and has conductivity. The thickness of the plate member 40 is substantially equal to the thickness of the first side part 31. The material of the plate member 40 is aluminum, an aluminum alloy, or the like. In addition, the material of the plate member 40 may be, for example, a clad material obtained by rolling and joining: a metal layer made of one or more of Fe (iron), Cu (copper), Ni (nickel), stainless steel, an iron alloy, a copper alloy, and a nickel alloy; and an aluminum layer. Furthermore, for example, a composite member that has a three-layer structure of an Al (aluminum) layer, a stainless steel layer, and a nickel layer may be applied to the plate member 40. The type of stainless steel is not particularly limited, and for example, SUS304, SUS316, and the like.

The plate member 40 is disposed inside the through hole 31a to be separated from the first side part 31 in a plan view from the first side part 31. The plate member 40 faces the first end surface 10a of the electrode body 10. The plan view from the first side part 31 has a gap G between the first side part 31 and the plate member 40 over the whole perimeter of the peripheral edge of the plate member 40. The plate member 40 is electrically insulated from the box member 30 by the gap G.

As shown in FIG. 3, the positive electrode terminal 11 is joined by, for example, laser welding to the inner surface of the plate member 40. Thus, the plate member 40 is electrically connected to the positive electrode terminal 11.

In addition, the battery 1 further includes a first insulator 60 and a second insulator 70. The first insulator 60, which has a strip shape, is disposed on the positive electrode terminal 11. The first insulator 60 electrically insulates the positive electrode terminal 11 from the exterior member 20. The second insulator 70 is disposed on the first end surface 10a of the electrode body 10. The second insulator 70 electrically insulates the positive electrode terminal 11 from the negative electrode.

The sealing body 50 seals the gap G between the first side part 31 and the plate member 40. The sealing body 50 has an annular shape in a plan view. The sealing body 50 is overlapped with the first side part 31, the plate member 40, and the gap G in a plan view from the first side part 31. The sealing body 50 is disposed on the outer surface of the first side part 31. The plate member 40 is exposed from the inside of the sealing body 50.

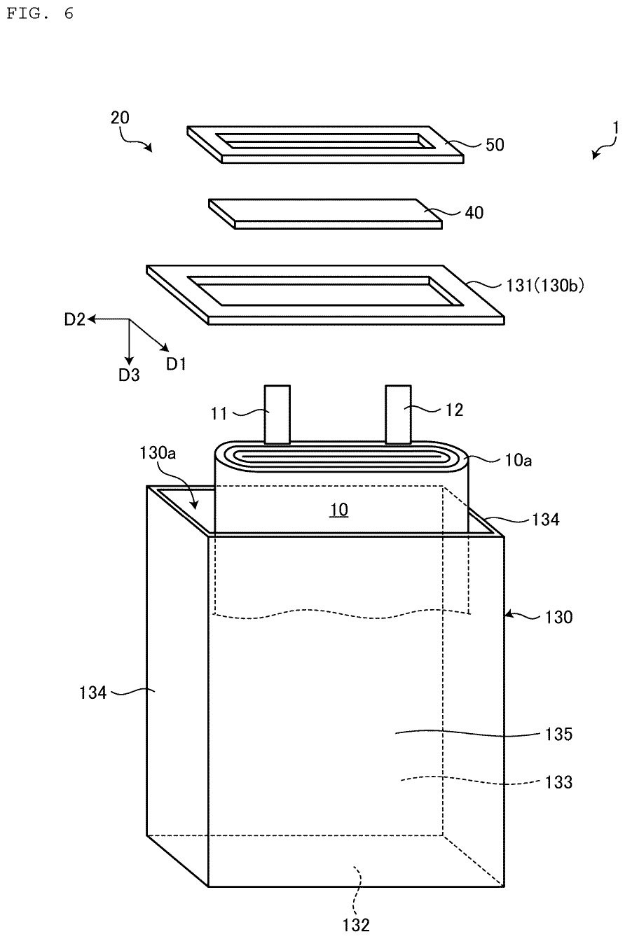

FIG. 5 is an enlarged sectional view of a part of the sealing body 50 shown in FIG. 3. The sealing body 50 includes a substrate layer 51, a joining layer 52, and a protective layer 53.

The material of the substrate layer 51 is, for example, stainless steel. The type of stainless steel is not particularly limited, and specific examples thereof include SUS304 and SUS316. In addition, the material of the substrate layer 51 may be, for example, a simple metal such as aluminum, iron, copper, and nickel, and alloys thereof, that is, an aluminum alloy, an iron alloy, a copper alloy, a nickel alloy, and the like.

The joining layer 52 is overlapped with the substrate layer 51 to join the first side part 31 and the plate member 40 to the substrate layer 51. The joining layer 52 has an electrical insulation property. The material of the joining layer 52 is a thermoplastic resin. The material of the joining layer 52 is, for example, polypropylene (PP), polyethylene (PE), or the like. In addition, the material of the joining layer 52 may be unstretched polypropylene (CPP), polyphenylene sulfide (PPS), or the like.

The protective layer 53 is overlapped with the substrate layer 51 on the side opposite to the joining layer 52 to protect the substrate layer 51. The protective layer 53 has an electrical insulation property. The heat resistance of the protective layer 53 is higher than the heat resistance of the joining layer 52. The material of the protective layer 53 is a thermoplastic resin. The material of the protective layer 53 is, for example, nylon, polyethylene terephthalate (PET), or the like.

The sealing body 50 is joined by thermal welding to the first side part 31 and the plate member 40. The joint strength between the sealing body 50 and the first side part 31 and plate member 40 is smaller than the joint strength between the housing part 30a and the lid 30b in the box member 30.

In addition, when the internal pressure of the exterior member 20 is equal to or higher than a predetermined pressure, the sealing body 50 is cleaved. More specifically, the sealing body 50 functions as a cleavage valve. The predetermined pressure is a pressure at which the safety of battery 1 can be ensured.

For example, when the positive electrode and the negative electrode are short-circuited in the electrode body 10, gas is generated from the electrode body 10, and the electrode body 10 abnormally generates heat. Thus, the joining layer 52 is softened, and when the internal pressure of the exterior member 20 reaches the predetermined pressure or higher, the joining layer 52 is cleaved, and the gas leaks from the gap G. Accordingly, the internal pressure of the exterior member 20 is kept from being increased, and the safety of the battery 1 is secured.

The respective materials and thicknesses of the substrate layer 51, joining layer 52, and protective layer 53 are determined such that the sealing body 50 is cleaved when the internal pressure of the exterior member 20 is equal to or higher than the predetermined pressure.

As described above, inside the box member 30, the third side part 33 and the fifth side part 35 face each other with the electrode body 10 interposed therebetween in the first direction D1, the pair of fourth side parts 34 face each other with the electrode body 10 interposed therebetween in the second direction D2, and the first side part 31 and the second side part 32 face each other with the electrode body 10 interposed therebetween in the third direction D3. In addition, the positive electrode terminal 11 and the negative electrode terminal 12 are both disposed on the first end surface 10a, and thus, the first side part 31 faces the first end surface 10a of the electrode body 10 where the positive electrode terminal 11 and the negative electrode terminal 12 are located.

When the positive electrode terminal 11 and the negative electrode terminal 12 are both disposed on the first end surface 10a, the gap between the second side part 32 and the electrode body 10 can be reduced, for example, as compared with a case where the positive electrode terminal 11 is disposed on the first end surface 10a, whereas the negative electrode terminal 12 is disposed on the second end surface 10b. Similarly, when the positive electrode terminal 11 and the negative electrode terminal 12 are both disposed on the first end surface 10a, the gap between the third side part 33, pair of fourth side parts 34, and fifth side part 35 and the electrode body 10 can be reduced. Accordingly, the volume of the electrode body 10 can be increased with respect to the volume of the exterior member 20.

In addition, the plate member 40 has a flat plate shape that has a thickness substantially equal to the thickness of the first side part 31, and is located inside the through hole 31a of the first side part 31. More specifically, the plate member 40 is kept from being located inside the box member 30. Furthermore, the sealing body 50 is disposed on the outer surface of the first side part 31. Thus, the thickness of the member disposed on the first side part 31 in the third direction D3 can be reduced. Thus, the gap between the first side part 31 and the electrode body 10 can be reduced. Accordingly, the volume of the electrode body 10 can be increased with respect to the volume of the exterior member 20. More specifically, the capacity of the battery 1 can be increased.

In addition, as mentioned above, in the electrode body 10, the area of the first end surface 10a corresponding to the projected area in the third direction is smaller than the first projected area in the first direction D1 and the second projected area in the second direction D2. Thus, when the positive electrode terminal 11 and the negative electrode terminal 12 are located on the first end surface 10a, the gap between the electrode body 10 and the box member 30 can be reduced as compared with a case where the positive electrode terminal 11 and the negative electrode terminal 12 are located on a site of the electrode body 10 facing the third side part 33 or the fourth side part 34. Accordingly, the capacity of the battery 1 can be further increased.

In addition, as mentioned above, the sealing body 50 functions as a cleavage valve. More specifically, the battery 1 does not need to separately include any cleavage valve. Thus, for the battery 1, the number of parts can be reduced, the manufacturing process can be reduced, and the cost can be reduced.

It is to be noted that the embodiments mentioned above are intended to facilitate understanding of the present disclosure, but not intended to construe the present disclosure in any limited way. The present disclosure may be modified or improved without departing from the spirit of the present disclosure, and the present disclosure includes equivalents of the present disclosure.

For example, the electrode body 10 may be a rectangular parallelepiped staked body that has a plurality of sheet-shaped positive electrodes and a plurality of sheet-shaped negative electrodes alternately stacked with separators interposed therebetween.

In addition, the housing part 30a may have no flange part F. In this case, the peripheral edge of the lid 30b is joined to the peripheral edge of the cavity of the housing part 30a.

FIG. 6 is an exploded perspective view of the battery 1 according to a modification example of the embodiment of the present disclosure. The battery 1 according to the present modification example differs from the battery 1 according to the embodiment mentioned above in the configuration of a box member 130. For the box member 130 according to the present modification example, a second side part 132, a third side part 133, a pair of fourth side parts 134, and a fifth side part 135, which are integrated, constitute a housing part 130a that is open on one side in the third direction D3. In addition, a first side part 131 constitutes a lid 130b that covers the cavity of the housing part 130a. The peripheral edge of the lid 130b is joined to the peripheral edge of the cavity of the housing part 130a over the whole perimeter. Further, in the present modification example, the pair of fourth side parts 134 may have arc sectional shape.

It is to be noted that the present disclosure may be a combination of the following configurations according to an embodiment.
(1)

A battery including:
an electrode body that has a first surface with a positive electrode terminal and a negative electrode terminal located; and
an exterior member that houses the electrode body,
in which the exterior member includes:
a box member that has a box shape including a flat plate-shaped first side part that faces the first surface and has a through hole, a flat plate-shaped second side part located across the electrode body from the first side part, and a flat plate-shaped third side part that connects the first side part and the second side part, the box member being electrically connected to the negative electrode terminal;
a plate member disposed inside the through hole to be separated from the first side part in a plan view from the first side part, and electrically connected to the positive electrode terminal; and
a sealing body overlapped with the first side part, the plate member, and a gap between the first side part and the plate member in the plan view from the first side part, the sealing body sealing the gap.
(2)

The battery according to (1), in which
the sealing body includes:
a substrate layer; and
a joining layer overlapped with the substrate layer to join the first side part and the plate member to the substrate layer.
(3)

The battery according to (2), in which a material of the joining layer is a thermoplastic resin.
(4)

The battery according to any one of (1) to (3), in which the sealing body is disposed on an outer surface of the first side part.
(5)

The battery according to any one of (1) to (4), in which when an internal pressure of the exterior member is equal to or higher than a predetermined pressure, the sealing body is cleaved.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
an electrode body that has a first surface with a positive electrode terminal and a negative electrode terminal located; and
an exterior member that houses the electrode body,
wherein the exterior member includes:
a box member that has a box shape including a flat plate-shaped first side part that faces the first surface and has a through hole, a flat plate-shaped second side part located across the electrode body from the first side part, and a flat plate-shaped third side part that connects the first side part and the second side part, the box member being electrically connected to the negative electrode terminal;
a plate member disposed inside the through hole to be separated from the first side part in a plan view from the first side part, and electrically connected to the positive electrode terminal; and
a sealing body overlapped with the first side part, the plate member, and a gap between the first side part and the plate member in the plan view from the first side part, the sealing body sealing the gap.

2. The battery according to claim 1, wherein
the sealing body includes:
a substrate layer; and
a joining layer overlapped with the substrate layer to join the first side part and the plate member to the substrate layer.

3. The battery according to claim 2, wherein a material of the joining layer includes a thermoplastic resin.

4. The battery according to claim 1, wherein the sealing body is disposed on an outer surface of the first side part.

5. The battery according to claim 1, wherein when an internal pressure of the exterior member is equal to or higher than a predetermined pressure, the sealing body is cleaved.
